(19) United States
(12) Patent Application Publication
(10) Pub. No.: US 2017/0357823 A1
(43) Pub. Date: Dec. 14, 2017

(54) SECURITY AND LIMITED, CONTROLLED DATA ACCESS

(71) Applicant: KONINKLIJKE PHILIPS N.V., EINDHOVEN (NL)

(72) Inventor: John Corydon Huffman, Portland, OR (US)

(21) Appl. No.: 15/527,533

(22) PCT Filed: Nov. 20, 2015
(86) PCT No.: PCT/IB2015/058991

§ 371 Date: May 17, 2017

Related U.S. Application Data
(60) Provisional application No. 62/219,791, filed on Sep. 17, 2015.
(60) Provisional application No. 62/082,253, filed on Nov. 20, 2014.

(51) Int. Cl. G06F 21/62; G06F 19/00

(52) U.S. Cl. CPC G06F 21/6245; G06F 19/322

(57) ABSTRACT

When transferring a patient's medical records or other healthcare data, an authentication module (201) receives user identification information and authenticates a user. A data service (300) receives a request for healthcare data of the user from a potential recipient, transmits to the user an electronic consent form, and receives from the user a completed electronic consent form with selected healthcare data and one or more selected data recipient information entered therein. The data service requests a confirmation from a messaging service of user approval for the transfer of the selected healthcare data, receives the confirmation from the messaging service, and transmits the selected healthcare data to the one or more selected recipients. The healthcare data can be partitioned according to one or more metrics so that the user can authorize transfer of all or a portion of the user's data.

The present invention finds application in patient healthcare record management systems and methods. However, it will be appreciated that the described techniques may also find application in other secure data systems, other private data transfer techniques, and the like.

In many industries, healthcare in particular, there are strong laws, rules and regulations covering the ownership of data and the need for informed consent in any access or transfer of critical data. This complicates making data available in critical situations. For example, if one is traveling and has a healthcare event in which local care or hospitalization is required, there is no easy way to access healthcare information because of privacy regulations and the need for informed consent from the patient to access the data. Even the simple case of requesting data to be transferred from one institution to another is complicated because of this need for informed consent.

The present application provides new and improved systems and methods that facilitate generating and editing patient episodes of care, as well as categorizing care events, thereby overcoming the above-referenced problems and others.

In accordance with one aspect, a system that facilitates providing a master data exchange service for multi-factor secure patient data transfer comprises a user interface via which a user enters a user identification information, and an authentication module that receives the user identification information and authenticates the user. The system further comprises a data service configured to receive a request for healthcare data of the user from a potential recipient, transmit to the user an electronic consent form comprising selectable options for selecting healthcare data and data recipients, and receive from the user a data transfer request comprising the electronic consent form with selected healthcare data and selected data recipient information entered therein. The data service is further configured to request a confirmation from a messaging service of user approval for the transfer of the selected healthcare data, receive the confirmation from the messaging service, and transmit the selected healthcare data to one or more selected recipients.

According to another aspect, a method for providing a master data exchange service for multi-factor secure patient data transfer comprises receiving user identification information from a user interface, authenticating a user, receiving a request for healthcare data of the user from a potential recipient, and transmitting to the user an electronic consent form comprising selectable options for selecting healthcare data and data recipients. The method further comprises receiving from the user a data transfer request comprising the electronic consent form with selected healthcare data and selected data recipient information entered therein, requesting a confirmation from a messaging service of user approval for the transfer of the selected healthcare data, receiving the confirmation from the messaging service, and transmitting the selected healthcare data to one or more selected recipients.

According to another aspect, a system that facilitates providing a master data exchange service for multi-factor secure patient data transfer comprises an authentication module (201) that receives user identification information and authenticates a user, and a data service (300) configured to receive a request for healthcare data of the user from a potential recipient, and transmit to the user an electronic consent form. The data service is further configured to receive from the user a completed electronic consent form with selected healthcare data and one or more selected data recipient information entered therein, request a confirmation from a messaging service of user approval for the transfer of the selected healthcare data, receive the confirmation from the messaging service, and transmit the selected healthcare data to the one or more selected recipients.

Still further advantages of the subject innovation will be appreciated by those of ordinary skill in the art upon reading and understand the following detailed description.

The drawings are only for purposes of illustrating various aspects and are not to be construed as limiting.

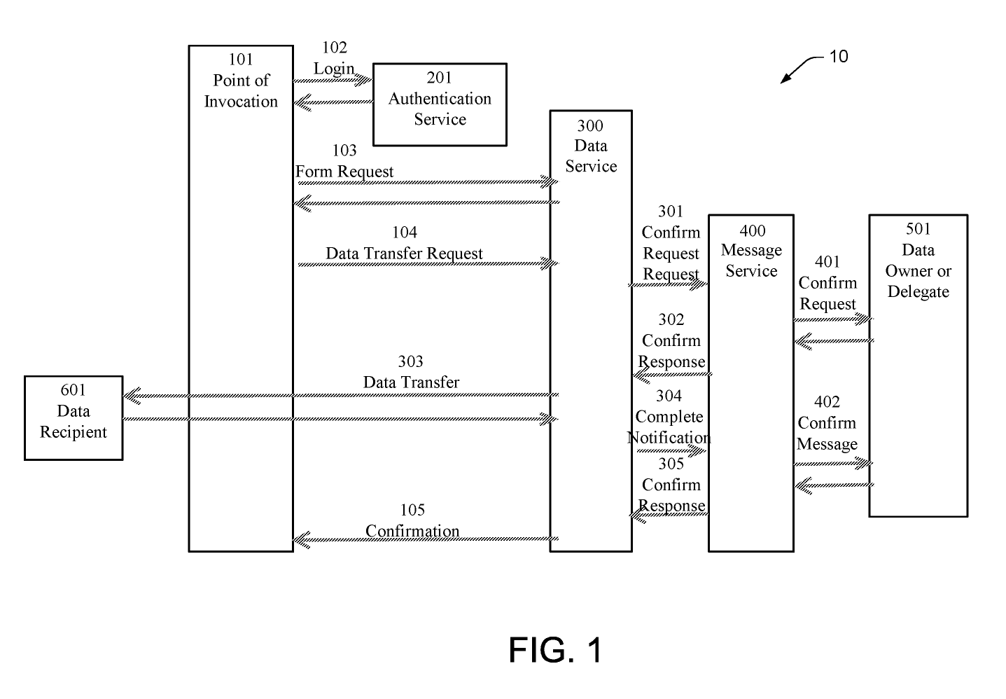

FIG. 1 illustrates a flow diagram that depicts an authentication and authorization communication flow in accordance with one or more features described herein.

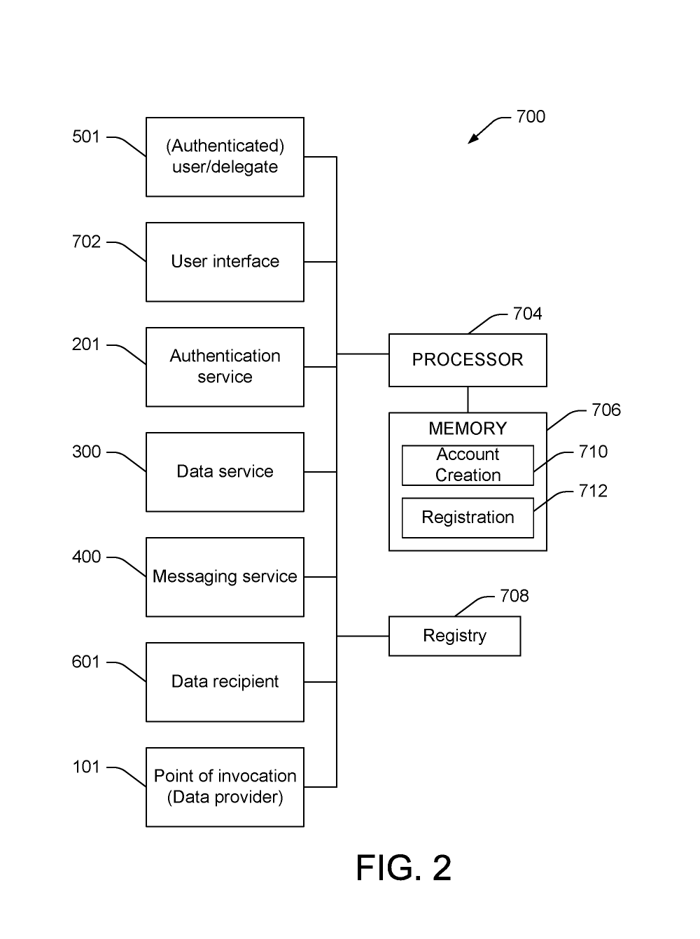

FIG. 2 illustrates a system that facilitates providing a master data exchange service for multi-factor secure patient data transfer, in accordance with various features described herein.

The described systems and methods overcome the above-mentioned problems by providing multi-factor secure data transfer between two individuals, sites or institutions. The innovation addresses the need for multi-factor authentication and authorization for the transfer of critical patient information. The described systems and methods, which facilitate requesting and authorizing data access and/or transfer in a secure way which meets the requirements for informed consent under the HIPAA regulations and any other relevant local, national or international laws, rules and regulations overcome the above-mentioned problems and provide improved healthcare benefits in the case of the access and transfer of healthcare information.

FIG. 1 illustrates a flow diagram 10 that depicts an authentication and authorization communication flow in accordance with one or more features described herein. A point of invocation 101 marks the beginning of the data access and/or transfer process. The point of invocation can be an embedded object in a web page, or at a kiosk or institution. The basic invocation involves entering a user identifier, e.g. a user name, an account number, or some other unique identifier, and an associated password in order to login, at 102, to an authentication service 201. No data access occurs at this point.

The authentication service 201 receives the user identifier and related password and confirms correctness. If the authentication is affirmed, a request for a data access/transfer form 103 is made to a data service 300. The data service initially returns a form that is populated with options available to the authenticated user. These options are the data sets and/or subsets available to the authenticated user to transfer, and the valid recipient options for the data. Once the data [sub]set is selected, and the target recipient selected, the form is submitted back to the data service as a data transfer request 104. The data service then requests a confirmation 301 from a messaging service 400. The messaging service then sends a data transfer confirmation request 401 to the authenticated user (the patient and data owner) or an authorized delegate 501 therefor, who in turn responds with a data transfer confirmation message 402 to the messaging service. The messaging service sends a confirmation 302 to the data service 300, and the data encapsulation and transfer 303 is performed. Upon completion, the messaging service is contacted again to convey a confirmation of the completed transaction 304 to the authenticated user or delegate 501, and to the invoking agent.

The messaging service 400 queries a registry of authenticated user information to determine the confirmation method to use. In one embodiment, an SMS message is sent to the authenticated user or delegate 501, as a request to confirm 401 the data transfer. The authenticated user or delegate 501 is the individual or delegate that has the authority to approve the request for data access and/or transfer.

The authenticated user or delegate 501 then confirms consent via the confirmation message 402 for the data access and/or transfer request, which is then relayed by the messaging service as the message 305 to the data service, which relays at 105 the confirmation message to the point of invocation. The method used for consent confirmation can be augmented by bio-identification information such as fingerprint, retina scan information, facial recognition, voice recognition, or other multi-factor approaches. The messaging service returns the confirmation response to the data service. A data recipient 601 (e.g., an individual or institution) is a verified valid recipient of the data being accessed and/or transferred.

According to an example, an individual goes to a web site with an embedded object to login to a master data exchange, or “data service.” After authentication, a web form is returned that includes options for data type to be accessed or transferred, and the data recipient. These options can be populated via a web service to dynamically update the options from configured repositories of users, data sources and data recipients. The populated form is returned and the invoking user is contacted via the configuration information in the user's account. The invoking user is contacted and requested to approve the data to be accessed or transferred, and the recipient. After the acceptance is received, the data transfer is executed and the completed transfer is confirmed to the invoking user and the data owner.

In another example, the data repository has no knowledge of the content of the data, but rather is an opaque repository. In one embodiment, the data transfer authorization agent can act as a broker. In this case, the broker has a priori knowledge about the existence and location of the data, and has the ability to access the different directories (e.g., patient, healthcare provider, etc.) of valid actors to broker the data transaction. The actual data transaction then need not be passed through the broker. This scenario represents an additional level of security whereby a key can be held by a third party. The data transfer can be performed, but the data remains encrypted and can only be accessed with the associated key.

FIG. 2 illustrates a system that facilitates providing a master data exchange service for multi-factor secure patient data transfer, in accordance with various features described herein. The components of FIG. 2 may be connected via the Internet or any other suitable connection for enabling communication there between. A point of invocation (a data provider) 101 such as a first healthcare provider detects that potential data recipient (e.g., a second healthcare provider, insurance company or the like) would like to receive a medical records or the like for a given user 501 (e.g., a patient or delegate therefor). For instance, the user can employ a user interface 702 to enter user identifier, e.g. a user name, an account number, or some other unique identifier, and an associated password in order to login to an authentication service 201. In another embodiment, the user swipes a credit card or ID card that has been registered with a registration database or server, or the like.

The authentication service 201 receives the user identifier and related password (or other identification information) and confirms correctness. If the authentication is affirmed, a request for a data access/transfer form is made to a data service 300. The data service initially returns a form that is populated with options available to the authenticated user. These options are the data sets and/or subsets available to the authenticated user to transfer, and the valid recipient options for the data. Once the data [sub]set is selected, and the target recipient selected, the form is submitted back to the data service as a data transfer request 104. The data service requests a confirmation 301 from a messaging service 400. The messaging service sends a data transfer confirmation request 401 to the authenticated user (the patient) or an authorized delegate 501 therefor, who in turn responds with a data transfer confirmation message 402 to the messaging service. The messaging service sends a confirmation 302 to the data service 300, and the data encapsulation and transfer 303 is performed. Upon completion, the messaging service is contacted again to convey a confirmation of the completed transaction 304 to the authenticated user or delegate, and to the invoking agent.

The messaging service 400 queries a registry of authenticated user information to determine the confirmation method to use. In one embodiment, an SMS message is sent to the authenticated user or delegate 501, as a request to confirm 401 the data transfer. The authenticated user or delegate 501 is the individual or delegate that has the authority to approve the request for data access and/or transfer.

The authenticated user or delegate 501 then confirms consent via the confirmation message 402 for the data access and/or transfer request, which is then relayed by the messaging service as the message 305 to the data service, which relays at 105 the confirmation message to the point of invocation. The method used for consent confirmation can be augmented by bio-identification such as fingerprint, or other multi-factor methods. The messaging service returns the confirmation response to the data service. A data recipient 601 (e.g., an individual or institution) is a verified valid recipient of the data being accessed and/or transferred.

It will be understood that the processor 704 executes, and the memory 706 stores, computer executable instructions for carrying out the various functions and/or methods described herein. The memory 706 may be a computer-readable medium on which a control program is stored, such as a disk, hard drive, or the like. Common forms of computer-readable media include, for example, floppy disks, flexible disks, hard disks, magnetic tape, or any other magnetic storage medium, CD-ROM, DVD, or any other optical medium, RAM, ROM, PROM, EPROM, FLASH-EPROM, variants thereof, other memory chip or cartridge, or any other tangible medium from which the processor 704 can read and execute. In this context, the described systems may be implemented on or as one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphics processing unit (GPU), or PAL, or the like.

There are a number of ancillary services that can be employed to configure the solution, such as account creation and data recipient registration. The account creation process comprises user identifier and password creation. This can be for an individual, or institution. Account configuration also comprises contact information for SMS or some other confirmation mechanism. Different types of user account creation can be employed, such as consumer or individual, credentialed or licensed professional, institutional, etc.

For healthcare solutions, there are specific extensions employed for patient care situations. A “break glass” situation, such as when patient information is required, but patient consent is not available may arise, such as when a patient is unconscious. In this case, a user or institution with appropriate recorded credentials can override the data access security to access the patient healthcare information. The invoking user is informed that this action will be recorded (audited), and reported.

The data recipient registration process comprises the specification of individuals or institutions that are able to accept data transfers from the data service. For example, for healthcare solutions, these could be derived from a healthcare provider directory (HPD) repository. The referenced components and services can be located together, or separately at different locations or in the cloud.

According to one example, a user (e.g., patient) creates an account with, for instance, a user name and a password as well as contact information (e.g., phone number for SMS communication, email, etc.). The user lists at least one healthcare provider that has the user's healthcare information (e.g., medical records, etc.). In order to exchange healthcare information from the listed healthcare provider to a new healthcare provider, the patient logs in to a data exchange service or server at a new point of service (e.g., the new healthcare provider (e.g., nursing home, doctor's office, hospital, etc.) Login may be via a user interface (e.g., a computer at the point of service), the user's cellular or Wi-Fi communication device while logged in to the new healthcare providers wireless router etc. In another embodiment, the user swipes a driver's license, registered credit care, health insurance card, debit card, etc., or any other suitable card that is associated with the user.

Once the user is logged in, the user receives a communication (e.g., a text or SMS message, an email, or the like) on his communication device. The communication indicates that the new healthcare provider is requesting the user's healthcare information from the original (listed) healthcare provider. The user confirms that the request is valid via return SMS, email, or other means of communication. The user then receives an electronic consent form via which the user can indicate that some or all of the user's healthcare data can be transferred, and/or to whom the selected data or subset thereof may be transferred. The user transmits the completed consent form back to the requesting entity. Once the transfer is complete, the user receives a confirmation message confirming transfer of the selected healthcare data to the approved or selected parties (e.g., the new healthcare provider).

According to another embodiment, the patient healthcare data can be partitioned according to one or more parameters. For instance, the healthcare data can be partitioned according to medical event (e.g., emergency room visit, doctor's office visit on a particular date, or the like). In another example, the healthcare data can be partitioned according to medical diagnosis (e.g., sleep apnea, Parkinson's syndrome, bursitis, pulmonary edema, etc.). According to another example, the data is partitioned according to date range (e.g., past 6 months, calendar year(s), past 2 years, etc.) In yet another embodiment, the healthcare data is partitioned according to the healthcare provider that collected the data (e.g., Hospital X, dentist Y, doctor Z, etc.). It will be appreciated that the foregoing examples are provided for illustrative purposes only, and are not intended to limit the manner in which the data is partitioned for selection by the user for transfer.

The consent form sent to the user can be prepopulated with partitioned data for selection by the user. For instance, the user can select to transfer only data associated with, for instance, a particular medical event (e.g., particular doctor visit or other visit to a healthcare provider, or the like). In another example, the user can select to transfer only data related to a particular medical diagnosis (e.g., tendonitis, cardiac arrhythmia, etc.).

According to another example, the data is partitioned according to date range (e.g., past 3 months, past 2 years, particular calendar year(s), date range, etc.) In yet another embodiment, the user can select to transfer only data related to the healthcare provider that collected the data (e.g., particular doctor, hospital, or other healthcare institution, etc.). It will be appreciated that the foregoing examples are provided for illustrative purposes only, and are not intended to limit the manner in which the data is partitioned for selection by the user for transfer.

When using a delegate to provide consent, the user can pre-select the healthcare data that the delegate is authorized to transfer on the user's behalf. For instance, upon registration (e.g., when the user creates a user ID and password), the user can designate a delegate (e.g., a relative or other party) who has authorization to transfer all or a subset of the user's healthcare data. In one embodiment, the user provides partial authority to the delegate. For example, the user can authorize the delegate to transfer subsets of data, which can be partitioned in the manner described above with regard to data partitioning.

The innovation has been described with reference to several embodiments. Modifications and alterations may occur to others upon reading and understanding the preceding detailed description. It is intended that the innovation be construed as including all such modifications and alterations insofar as they come within the scope of the appended claims or the equivalents thereof.

1. A system that facilitates providing a data exchange service for secure patient data transfer, comprising:
a user interface via which a user enters a user identification information;
an authentication module that receives the user identification information and authenticates the user;
a data service configured to:
receive a request for healthcare data of the user from a potential recipient;
transmit to the user an electronic consent form comprising selectable options for selecting healthcare data and data recipients;
receive from the user a data transfer request comprising the electronic consent form with selected healthcare data and selected data recipient information entered therein;
request a confirmation from a messaging service of user approval for the transfer of the selected healthcare data;
receive the confirmation from the messaging service; and
transmit the selected healthcare data to one or more selected recipients.

2. The system according to claim 1, wherein the messaging service is configured to:
transmit a data transfer confirmation request to the user or an authorized delegate therefor;
receive a data transfer confirmation message from the user or authorized delegate;
transmit a confirmation to the data service; and
upon completion of the data transfer, transmit a confirmation of the completed transaction to the user or authenticated delegate, and to the one or more selected recipients.

3. The system according to claim 2, wherein the messaging service is further configured to:
query a registry of authenticated user information and determine a communication protocol to employ for transmitting the data transfer confirmation request and receiving the data transfer confirmation message.

4. The system according to claim 3, wherein the communication protocol is short message service (SMS).

5. The system according to claim 3, wherein the communication protocol is email.

6. The system according to claim 2, wherein the data transfer confirmation request includes a request for bio-authentication information, and wherein the data transfer confirmation message includes the requested bio-authentication information.

7. The system according to claim 6, wherein the bio-authentication information is a fingerprint.

8. The system according to claim 6, wherein the bio-authentication information includes retinal scan data.

9. The system according to claim 6, wherein the bio-authentication information includes facial recognition data.

10. The system according to claim 6, wherein the bio-authentication information includes voice recognition data.

11. A method for providing a data exchange service for secure patient data transfer, comprising:
receiving user identification information from a user interface;
authenticating a user;
receiving a request for healthcare data of the user from a potential recipient;
transmitting to the user an electronic consent form comprising selectable options for selecting healthcare data and data recipients;
receiving from the user a data transfer request comprising the electronic consent form with selected healthcare data and selected data recipient information entered therein;
requesting a confirmation from a messaging service of user approval for the transfer of the selected healthcare data;
receiving the confirmation from the messaging service; and
transmitting the selected healthcare data to one or more selected recipients.

12. The method according to claim 11, wherein further comprising:
transmitting a data transfer confirmation request to the user or an authorized delegate therefor;
receiving a data transfer confirmation message from the user or authorized delegate;
transmitting a confirmation to the data service; and
upon completion of the data transfer, transmitting a confirmation of the completed transaction (304) to the user or authenticated delegate, and to the one or more selected recipients.

13. The method according to claim 12, further comprising:
querying a registry of authenticated user information and determine a communication protocol to employ for transmitting the data transfer confirmation request and receiving the data transfer confirmation message.

14. The method according to claim 13, wherein the communication protocol is short message service (SMS).

15. The method according to claim 13, wherein the communication protocol is email.

16. The method according to claim 12, wherein the data transfer confirmation request includes a request for bio-authentication information, and wherein the data transfer confirmation message includes the requested bio-authentication information.

17. The method according to claim 16, wherein the bio-authentication information is a fingerprint.

18. The method according to claim 16, wherein the bio-authentication information includes retinal scan data.

19. The method according to claim 16, wherein the bio-authentication information includes facial recognition data.

20. The method according to claim 16, wherein the bio-authentication information includes voice recognition data.

21. A system that facilitates providing a data exchange service for secure patient data transfer, comprising:
an authentication module that receives user identification information and authenticates a user;
a data service configured to:
receive a request for healthcare data of the user from a potential recipient;
transmit to the user an electronic consent form;
receive from the user a completed electronic consent form with selected healthcare data and one or more selected data recipient information entered therein;
request a confirmation from a messaging service of user approval for the transfer of the selected healthcare data;
receive the confirmation from the messaging service; and
transmit the selected healthcare data to the one or more selected recipients.
